(19) United States
(12) Patent Application Publication
(10) Pub. No.: US 2006/0082082 A1
(43) Pub. Date: Apr. 20, 2006

(54) Collapsible carrier for child car seat

(76) Inventor: Bonnie Bowes Reinke, Southlake, TX (US)

Correspondence Address: LOCKE LIDDELL & SAPP LLP;ATTN: SUE COTT, 2200 ROSS AVENUE, SUITE 2200, DALLAS, TX, 75201-6776, US

(21) Appl. No.: 10/957,239

(22) Filed: Oct. 1, 2004

(51) Int. Cl. B62B 13/00

(52) U.S. Cl. 280/14.21

(57) ABSTRACT

A collapsible carrier for a child car seat, including pivotably connected body and base portions, a handle telescoping from the body, a strap device, and rollers supporting the body and base above an underlying surface. The strap device and a retainer member on the base cooperate to support a child car seat during use. The carrier is collapsible following use for storage inside a bag.

### TECHNICAL FIELD

The present invention relates to a collapsible carrier with rollers that can conveniently be used, for example, to support and roll a child car seat through an airport and then collapsed and stored inside a carry-on bag once inside an airplane.

### BACKGROUND OF THE INVENTION

Child car seats are cumbersome and difficult to carry, especially for parents traveling with small children, who often have other items to carry at the same time. This is especially true for airline passengers, who must take the car seat through airports for use on a plane. A lightweight and inexpensive carrier is needed that facilitates transporting a child car seat through an airport and that can also be collapsed quickly and stored in a carry-on bag following use.

Collapsible car seat carriers that act as strollers are disclosed, for example, in the art: U.S. Pat. No. 5,499,831 to Worth and U.S. Pat. No. 5,121,940 to March. Major disadvantages of these designs are the weight and size of the folding carrier. Even when collapsed, these carriers are still too large to fit into most bags, and they weigh too much to be easily maneuvered. These carriers are designed to hold the car seat at a normal stroller height, and they must provide tremendous stability to safely support a baby riding in the seat as it is being transported.

U.S. Pat. No. 4,822,064 to Hunter and U.S. Published Application 2001/0009325 A1 to Santos each disclose a car seat carrier having wheels and a handle permanently attached to the car seat. This type of design solves the problem of where to store the carrier when not in use. Attachment of this carrier undesirably requires the use of bolts and screws. The carrier cannot be secured to the seat quickly and easily, and is not suitable for applications requiring quick assembly and release. Also, any dirt or mud that is collected on the wheels during use is deposited in the car when the device is used as a child's car seat.

Collapsible, wheeled carriers designed primarily for luggage are disclosed, for example, in U.S. Pat. No. 3,612,563 to Kazmark; U.S. Pat. No. 5,685,552 to Osaki; U.S. Pat. No. 4,426,099 to Gross; and U.S. Pat. No. 4,478,429 to Adams. A major disadvantage of these inventions for carrying car seats is that they are not designed to carry an object with this unique shape. The risers and bases on these devices intersect perpendicularly when fully extended, which provides adequate support for luggage that is generally rectangular in shape. Car seats are not rectangular in shape, and the base and back of car seats form an angle much greater than ninety degrees. To adequately support a car seat, the base and riser of a carrier must not lock at ninety degrees. They should be able to expand past this so that the when the base of the car seat is on the base of the carrier, the riser of the carrier can slant upward at the same angle as the back of the car seat. Also luggage generally weighs more than a car seat, and these carriers were designed to support a greater weight than necessary to simply carry a child car seat.

The present invention is designed to overcome these disadvantages by providing a lightweight, sturdy, easily removable, collapsible carrier specifically designed for use in transporting a child car seat by pulling it on wheels across an underlying surface.

### SUMMARY OF THE INVENTION

The present invention is a collapsible carrier with rollers that has a telescoping handle and is specifically designed to be collapsible into a volume small enough to permit it to be stored, for example, inside a diaper bag when not in use. The carrier has pivotably connected body and base portions that, when fully extended, provide stable support for a child car seat. One or more straps are desirably provided for use in securing the child car seat on the carrier. A roller extension arm is pivotably connected to each side of the base to provide stable support as a child car seat is transported over a street, parking lot, sidewalk, floor, moving walkway, jetway, or the like, by the user. Once the child car seat is removed from the carrier, the roller extension arms can be pivoted upwardly to substantially reduce the overall width of the carrier.

In a preferred embodiment, the telescoping handle is long enough to allow the user to comfortably grasp and maneuver the carrier while walking or standing upright. The body and base can have many different configurations, but preferably cooperate to provide stable support for the child car seat. Biasing or detent mechanisms are preferably provided to maintain a preferred positional alignment between the body, base, roller extension arms and telescoping handle when the carrier is in the respective use and storage position. One skilled in the art can appreciate that additional rollers and other structural enhancements can be provided if desired, so long as the resultant carrier remains strong, lightweight and, when collapsed, compact. The strap or straps preferably include overlapping Velcro® closure segments, an adjustable quick-release buckle, or other similarly effective means for securing the child car seat to the carrier while permitting length adjustments for use with different sized car seats. In one embodiment, the subject carrier supports the child car seat only in an inverted position to prevent users from using the car seat and carrier as a stroller.

### BRIEF DESCRIPTION OF THE DRAWINGS

The apparatus of the invention is further described and explained in relation to the accompanying figures of the drawings in which:

FIG. 1 is a side elevation view of a preferred embodiment of the collapsible child car seat carrier of the invention, shown in its fully extended use position, with the alternative, upwardly pivoted, collapsed position of the base shown in dashed outline;

FIG. 2 is a front elevation view of a preferred embodiment of the collapsible child car seat carrier, shown in its fully extended use position, with the alternative, upwardly pivoted, collapsed position of the roller extension arms shown in dashed outline;

FIG. 3 is a detail view of the lower body section of the child car seat carrier as shown in FIG. 1, with the base (partially broken away) and roller extension arms shown in the fully extended, use position;

FIG. 4 is a rear elevation view of a preferred embodiment of the collapsible child car seat carrier, shown in its fully extended use position;

FIG. 5 is cross-sectional elevation view taken along line 5-5 of FIG. 3;

FIG. 6 is a top view of the base oriented in a position analogous to the fully extended position of FIG. 1;

FIG. 7 is a side elevation view of the base of FIG. 6;

FIG. 8 is a side elevation view of the carrier of FIG. 1, with the handle, base and roller extension arms all shown in the fully collapsed position;

FIG. 9 is a front elevation view of the carrier shown in FIG. 8;

FIG. 10 is a side elevation view of an alternative embodiment of the child car seat carrier of the invention, with a child car seat shown in phantom outline as preferably positioned on the carrier;

FIG. 11 is a front elevation view of the carrier of FIG. 10 in its fully extended position;

FIG. 12 is a side elevation view of the carrier of FIG. 10, shown in its fully collapsed position, with the extended position of the back, telescoping handle and straps handle shown in phantom outline;

FIG. 13 is a front elevation view of the carrier of FIG. 12;

FIG. 14 is a plan view of another alternative embodiment of the carrier of FIGS. 10-13; and

FIG. 15 is the same structure as in FIG. 10, but with a child car seat shown in phantom outline in an inverted position to prevent use as a stroller.

### DESCRIPTION OF THE PREFERRED EMBODIMENTS

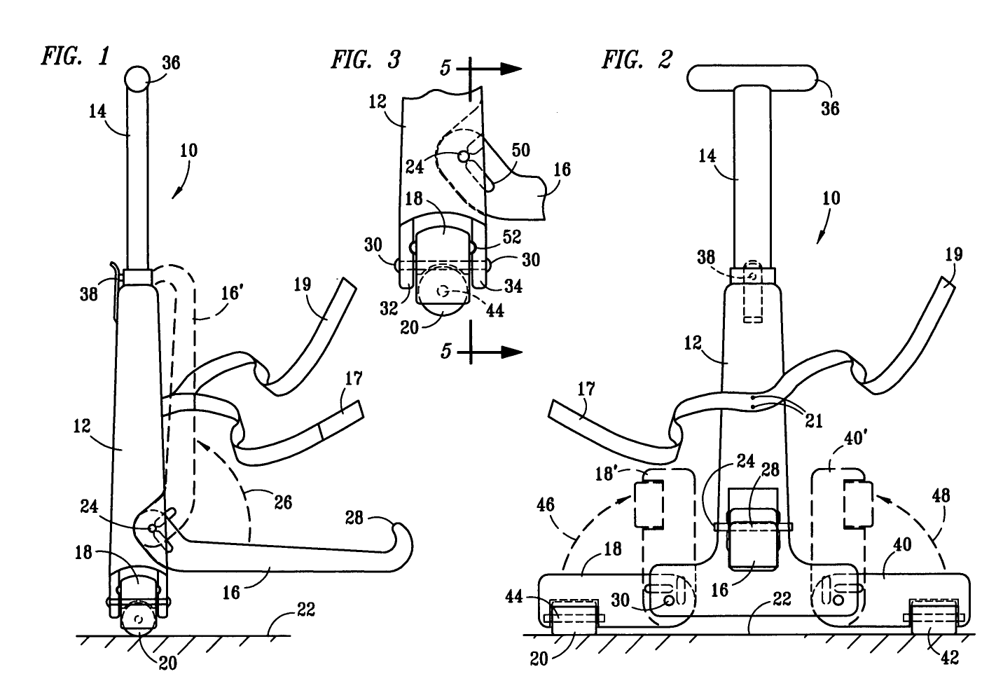

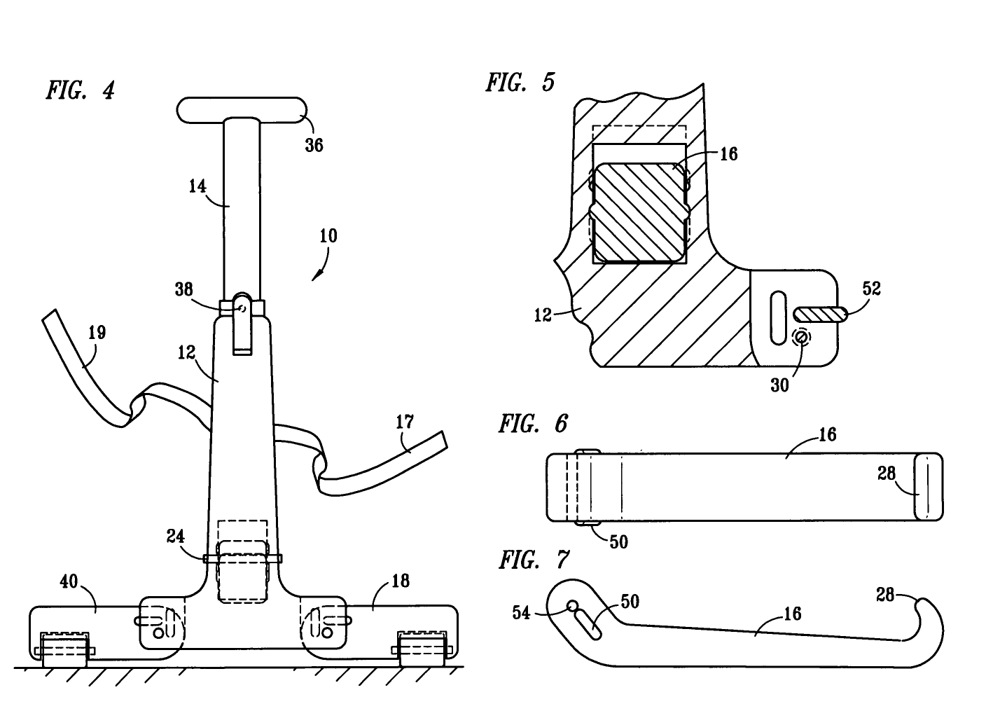

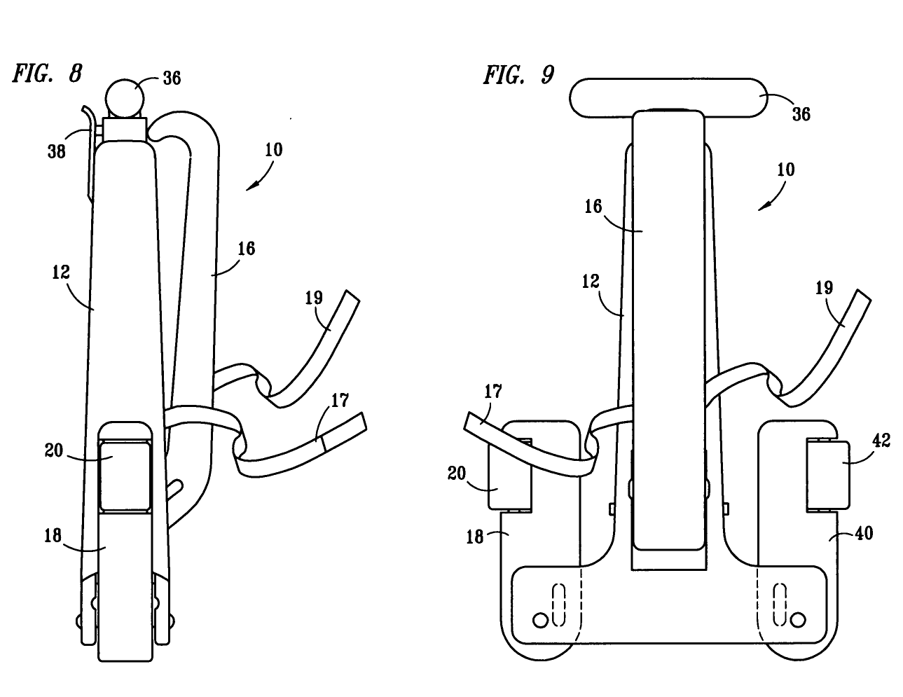

Referring to FIGS. 1-9, child car seat carrier 10 of the invention preferably comprises body 12, handle 14 that telescopes out of body 12 and terminates in T-shaped handgrip 36, base 16, roller extension arms 18, 40 having rollers 20, 42, respectively, and a retainer strap further comprising strap sections 17, 19. Body 12, handle 14, handgrip 36, base 16, roller extension arms 18, 40 and rollers 20, 42 are all preferably molded from well known impact resistant polymeric material, but it will be appreciated that other similarly effective materials such as metal, fiberglass or fiber-reinforced plastic can likewise be used, and that different materials can be used for different parts where desirable. Nylon and high impact polystyrene are illustrative examples of polymeric materials that can be used in making parts of the subject carriers, while aluminum is a preferred metal for use in making the body and base because of its relatively light weight. Rollers 20, 42 are desirably molded from a material that is less rigid than that used for making the body and base of carrier 10, and can be made of rubbery or elastomeric compounds having a durometer suitable for the intended use.

Rollers 20, 42 are desirably recessed into roller extension arms 18, 40 to reduce the overall width of carrier 10 when the arms are raised to the collapsed position as shown in FIG. 9, and to lower the center of gravity of the combined carrier and child car seat when the carrier is in use. The placement of rollers 20, 42 relative to roller extension arms 18, 40, body 12 and base 16 is desirably such that rollers 20, 42 can roll freely on underlying surface 22 when carrier 10 is in use.

Base 16 is preferably pivotably connected to body 12 by pin 24 and has a support surface that faces generally upward during use. Roller extension arms 18, 40 are pivotably connected to body 12 by pins 30. Rollers 20, 42 are preferably rotatably mounted on axles 44 attached to roller extension arms 18, 40. In FIG. 1, arrow 26 depicts the upward rotation of base 16 from its extended use position to the collapsed position 16′. In FIG. 2, arrows 46, 48 depict the upward rotation of roller extension arms 18, 40 from their extended use position to their respective collapsed positions 18′, 40′.

FIG. 3 depicts pairs of elongate projections 50, 52 that frictionally engage body 12 during pivoting and cooperate with corresponding recesses in body 12 to help bias base 16 and roller extension arms 18, 40 into their respective extended and collapsed positions. It should be understood, however, that projections 50, 52 are simply illustrative of many types of mechanisms well known to those of skill in the art that can be used to frictionally engage or otherwise bias base 12 and roller extension arms 18, 40 into the preferred extended and collapsed positions. Another such type of biasing mechanism is a biasing strip 38 made of plastic, spring steel, or the like, shown attached to body 12 in FIGS. 1, 2, 4 and 8 that has a projecting boss biased inwardly toward handle 14 to engage, preferably by friction, one or more recesses not shown in the drawings and thereby positively position handle 14 in either the use or collapsed position as desired.

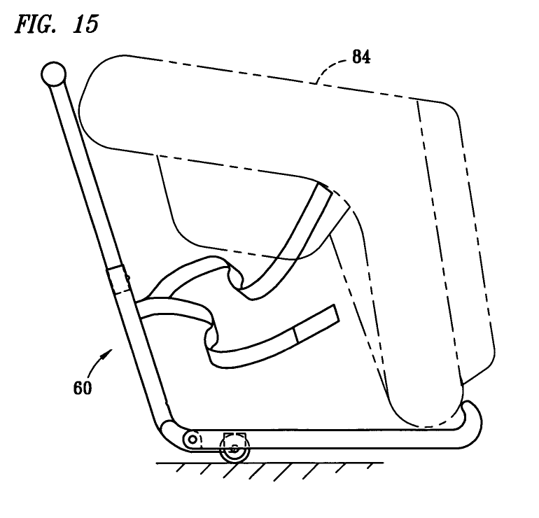

It will be apparent to those of skill in the art upon reading this disclosure that the forwardly extending portions of base 16 can be made wider if desired to provide additional support and stability to a child car seat transported on carrier 10. Alternatively, base 16 can be provided with one or more laterally extendable portions that can likewise be collapsed for storage prior to or following use. Retainer 28 at the forwardly extending end of base 16 can be shaped differently from the configuration shown in the drawings, provided that retainer 28 can effectively prevent a child car seat used with carrier 10 from sliding forwardly off base 16. In most cases, strap sections 17, 19 are sufficient to hold a child car seat on carrier 10 without direct restraint being exerted by retainer 28, unless perhaps if the child car seat is inverted as shown in conjunction with another embodiment of the invention in FIG. 15. Straps sections 17, 19 can be made of any suitable material, and will most preferably incorporate cooperating Velcro® hook and loop fastening sections at their free ends to facilitate quick attachment and release. Strap sections 17, 19 are desirably attached to body 12 by fasteners such as rivets 21 or other similarly effective means.

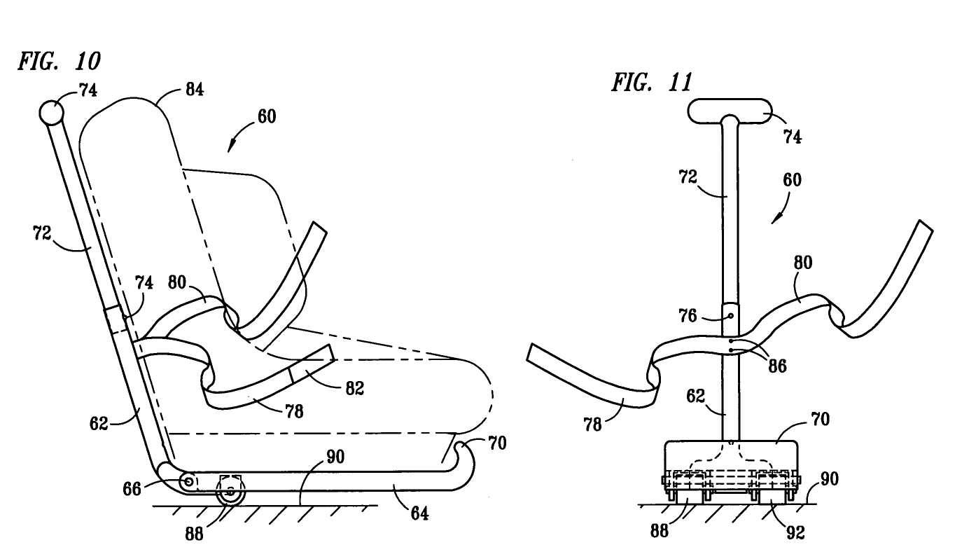

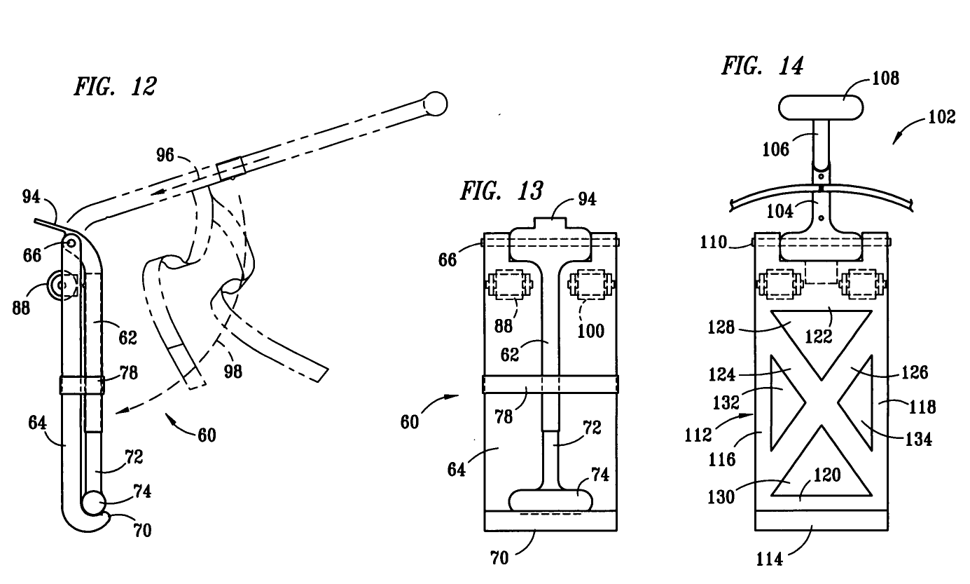

Another preferred embodiment of the invention is described in relation to FIGS. 10-15. Referring to FIG. 10, child car seat carrier 60 of the invention preferably comprises body 62, handle 72 that telescopes out of body 62 and terminates in T-shaped handgrip 74, base 64 having rollers 88, 92, and a retainer strap further comprising strap sections 78, 80. Body 62, handle 72, handgrip 74, base 64 and rollers 88, 92 are all preferably molded from well known impact resistant polymeric material, but it will be appreciated that other similarly effective materials such as metal, fiberglass or fiber-reinforced plastic can likewise be used, and that different materials can be used for different parts, such as the rollers, where desirable. Referring to FIGS. 11 and 13, rollers 88, 92 are desirably recessed into recesses 100 on the underside of base 64 to reduce the overall thickness of carrier 60 when carrier 60 is collapsed to the position shown in FIG. 12, and to lower the center of gravity of the combined carrier and child car seat relative to an underlying surface 90 when the carrier is in use.

Base 64 is preferably pivotably connected to body 62 by pin 66, and tailpiece 94 as shown in FIG. 12, or another similarly effective structure, is desirably provided at the end of body 62 opposite handle 72 to limit the included angle between body 62 and base 64 to an angle that is equal to or slightly greater than the angle that the back of the child car seat makes with its base. Rollers 88, 92 are preferably rotatably mounted on axles attached to bosses defining recesses 100 on the underside of base 64, opposite the upwardly facing seat support surface. Base 64 preferably further comprises retainer 70 having a configuration suitable for retaining the base (FIG. 10) or underside (FIG. 15) of a child car seat 84 relative to carrier 60 when used in combination with strap sections 78, 80. Referring to FIGS. 10 and 11, the lower portion of telescoping handle 72 preferably comprises a spring-load detent member 74 that is insertable through an orifice 76 in body 62 to lock handle 72 into its expanded position relative to body 62 during use.

Strap segment 78, 80 are desirably attached to body 62 by fasteners such as rivets 86 or other similarly effective means. The retainer strap Cooperating Velcro® hook and loop fastening sections, exemplified by end section 82 of strap segment 78, are preferably provided at the free ends of each strap segment to facilitate quick attachment and release of the child car seat 84 relative to carrier 60. The strap device is desirably sufficiently long that, when a child car seat is disposed on carrier 60, at least a portion of the child car seat supported on base carrier 60 is surrounded by the strap device and receives lateral support from the strap device.

FIGS. 12 and 13 illustrate carrier 60 in its collapsed storage position. In FIG. 12, arrow 96 depicts in dashed outline the manner in which part of handle 72 is collapsed downwardly into body 62 for storage, and arrow 98 depicts the downward rotation of body 62 from its use position, also shown in dashed outline, to the collapsed position shown in solid outline. FIGS. 12 and 13 illustrate the possible use of strap section 78 to secure body 62 to base 64 when carrier 60 is fully collapsed. Unlike the preferred embodiment depicted in FIGS. 1-9, FIG. 13 illustrates an embodiment where the width of base 64 is greater than that of body 62.

FIG. 14 depicts yet another preferred embodiment of the invention wherein child car seat carrier 102 comprises body 104, telescoping handle 106 terminating in handgrip 108, and base 112 pivotably connected to body 104 by pin 110. In this embodiment, base 112 does not have a continuous support surface as does base 64 in FIG. 13, and instead has diagonals 124, 126, which intersect to define voids 128, 130, 132 and 134 in cooperation with perimeter sections 116, 118, 120 and 122. Retainer 114, similar to retainer 70 as described in relation to FIG. 13, is provided at the end of base 112 that is opposite body 104.

FIG. 15 depicts carrier 60 as described above supporting child car seat 84, shown in phantom outline, in an inverted position. Longer straps may be required for this application. Although use of carrier 10 in this manner promotes safety by preventing use of the seat as a stroller to carry a child while attached to the carrier, which is not intended, it also raises the center of gravity of the combined seat and carrier, thereby making tipover more likely.

Other alterations and modifications of the structure and elements disclosed herein will become apparent to those of ordinary skill in the art upon reading this disclosure in relation to the accompanying drawings, and it is intended that the invention be limited only by the broadest interpretation of the appended claims to which the inventor is legally entitled.

What is claimed is:

1. A collapsible carrier for a child car seat, comprising:
a body, a handle telescoping from the body, first and second roller extension members pivotably connected to opposite sides of the body, a base pivotably connected to the body and comprising a support surface for a child car seat, and a strap device connected to the body above the base;
the body having a biasing mechanism engageable with the handle to selectively maintain the handle in either an extended or collapsed position relative to the body;
the roller extension members each comprising a roller partially recessed into the respective member and each roller extension member being frictionally engageable with a part of the body to selectively maintain the extension member in either an extended or collapsed position relative to the body;
the base comprising a proximal end and a distal end, the proximal end being pivotably connected to the body and further comprising a biasing mechanism frictionally engaging the body to selectively maintain the base in either an extended or collapsed position relative to the body, and the distal end further comprising a projecting retainer member that cooperates with the strap device to secure a child car seat to the child car seat carrier; and
the strap device comprising at least one flexible, elongate strap member, the strap device having sufficient length to surround and provide lateral support to a child car seat disposed on the base of the subject child car seat carrier.

2. The collapsible carrier of claim 1 comprising parts made from materials selected from the group consisting of polymers, reinforced polymers, metals, and combinations thereof.

3. The collapsible carrier of claim 1 wherein the child car seat is selectively receivable, supportable and securable in either an upright or inverted position.

4. The collapsible carrier of claim 1 wherein the handle further comprises a T-shaped handgrip at its distal end.

5. The collapsible carrier of claim 1 wherein the retainer member comprises a hook-shaped cross-section.

6. The collapsible carrier of claim 1 wherein the strap device comprises first and second strap ends.

7. The collapsible carrier of claim 1 wherein the strap device comprises at least one adjustable end closure.

8. The collapsible carrier of claim 1 wherein the strap device is riveted to the body.

9. A collapsible carrier for a child car seat, comprising:
a base having a support surface for a child car seat, a body pivotably connected to the base, a handle telescoping from a first end of the body, a tailpiece projecting from a second end of the body, and a strap device connected to the body between the base and the first end of the body;
the body having a biasing mechanism adjacent the first end that is engageable with the handle to selectively maintain the handle in either an extended or collapsed position relative to the body;
the tailpiece of the body being positioned to abut the base and thereby limit an included angle established between the body and the base when the body is pivoted away from the base;
the base comprising a proximal end and a distal end, the proximal end being pivotably connected to the body between the first end and the tailpiece, the distal end further comprising a projecting retainer member that cooperates with the strap device to secure a child car seat to the child car seat carrier, and further comprising at least two laterally spaced-apart rollers opposite the support surface; and
the strap device comprising at least one flexible, elongate strap member, the strap device having sufficient length to surround and provide lateral support to a child car seat disposed on the base of the subject child car seat carrier.

10. The carrier of claim 9 wherein the upwardly facing support surface of the base is continuous.

11. The carrier of claim 9 wherein the upwardly facing support surface is discontinuous.

13. The carrier of claim 9 wherein the strap device is riveted to the body.

14. The collapsible carrier of claim 9 comprising parts made from materials selected from the group consisting of polymers, reinforced polymers, metals, and combinations thereof.

15. The collapsible carrier of claim 9 wherein the child car seat is selectively receivable, supportable and securable in either an upright or inverted position.

16. The collapsible carrier of claim 9 wherein the handle further comprises a T-shaped handgrip at its distal end.

17. The collapsible carrier of claim 9 wherein the retainer member comprises a hook-shaped cross-section.

18. The collapsible carrier of claim 9 wherein the strap device comprises first and second strap ends.

19. The collapsible carrier of claim 9 wherein the strap device comprises at least one adjustable end closure.

20. The collapsible carrier of claim 9 wherein the strap device is riveted to the body.
